(19) United States
(12) Patent Application Publication
(10) Pub. No.: US 2026/0289374 A1
(43) Pub. Date: Sep. 24, 2026

(54) COMPUTING SYSTEM WITH GRAPHICS PROCESSING UNIT (GPU) OVERLAY WITH QUANTUM PROCESSING UNIT (QPU)

(71) Applicant: SEEQC, INC., Elmsford, NY (US)

(72) Inventors: Matthew Hutchings, London (GB); Oleg Mukhanov, Elmsford, NY (US); John Levy, Elmsford, NY (US)

(21) Appl. No.: 19/039,571

(22) Filed: Jan. 28, 2025

Related U.S. Application Data
(63) Continuation of application No. PCT/US24/25733, filed on Apr. 22, 2024.
(60) Provisional application No. 63/497,685, filed on Apr. 21, 2023.

(51) Int. Cl. G06N 10/60

(52) U.S. Cl. CPC G06N 10/60

(57) ABSTRACT

This patent document provides designs of efficient hybrid quantum classical computing systems capable of information processing based on both quantum computing using different quantum states of quantum bits and classical digital computing using digital processors including one or more graphics processing unit (GPU) processors.

### PRIORITY CLAIM AND RELATED PRIOR APPLICATION

This patent document is a continuation of, and claims the benefits of, International Patent Application No. PCT/US24/25733, entitled “COMPUTING SYSTEM WITH GRAPHICS PROCESSING UNIT (GPU) OVERLAY WITH QUANTUM PROCESSING UNIT (QPU),” filed on Apr. 22, 2024 and published as PCT Publication No. WO/2024/221003 on Oct. 24, 2024, which further claims the priority and benefits of U.S. Patent Application No. 63/497,685 entitled “COMPUTING SYSTEM WITH GRAPHICS PROCESSING UNIT (GPU) OVERLAY WITH QUANTUM PROCESSING UNIT (QPU)” and filed on Apr. 21, 2023. This patent document incorporates by reference the entire disclosures of the above prior applications as part of the disclosure of this patent document.

### TECHNICAL FIELD

This patent document relates to computing or information processing systems including quantum computing modules performing information processing or computing using quantum states of quantum mechanical devices or circuits.

### BACKGROUND

Classical digital computers are designed to perform computations based on Boolean logic. Computing technologies based on Boolean logic have revolutionized a wide range of industries and technologies for recent decades but have also exhibited certain limitations in performing highly complex or large numbers of computations, such as modeling of molecular structures and properties of chemical compounds or biological structures, cryptography, or modeling of complex systems for weather forecast, climate changes and others. Various new computation techniques have been investigated to supplement or replace Boolean logic based digital computing.

Quantum-mechanical systems can be used to construct new computation systems for complex information processing. A quantum system suitable for quantum computing has an ensemble of subsystems exhibiting different quantum states where subsystems are correlated or “entangled” with one another due to quantum coherence, including long-range quantum coherence. In various implementations for quantum computers, each subsystem in the ensemble of subsystems may be a quantum system exhibiting two or more different quantum states to operate as a fundamental quantum device and information can be represented, stored, processed, and transmitted by superposition and correlation of quantum states of different fundamental quantum devices. One example of such a fundamental quantum device is a two-state device known as a quantum bit (“qubit”). Some examples of implementations of qubits include superconducting qubits based on superconducting Josephson junctions developed at IBM, Google, Intel and others, ion trap devices based on electromagnetic trapping fields by laser beams developed at Honeywell and IonQ, and semiconductor-based quantum dots and other devices capable of quantum computing operations.

### SUMMARY

This patent document provides designs of efficient hybrid quantum classical computing systems capable of information processing based on both quantum computing using different quantum states of quantum bits and classical digital computing using digital processors including one or more superconducting digital processors and one or more graphics processing unit (GPU) processors.

For example, in some embodiments, the technology disclosed in this patent document can be implemented to provide a method for computing based on both quantum computing using different quantum states of quantum bits and classical digital computing using digital processors including one or more graphics processing unit (GPU) processors. This method includes operating a quantum computing module, that includes different quantum bit circuits that exhibit different quantum states, to perform quantum computing operations; producing readout signals indicative of quantum states of the quantum bit circuits of the quantum computing module; operating hierarchical quantum error correction decoding and hybrid quantum-classical co-processing circuit modules exhibiting different processing latencies and different decoding complexity levels in processing readout signals of the quantum bit circuits of the quantum computing module; and operating a graphics processing unit (GPU) overlay module, that includes one or more graphics processing unit (GPU) processors and a decoding module which are coupled to communicate with the hierarchical quantum error correction decoding and hybrid quantum-classical co-processing circuit modules, to perform quantum error correction decoding and hybrid quantum-classical co-processing based on quantum error correction decoding operations performed by the hierarchical circuit modules to carry out GPU processing operations.

For example, in other embodiments, the technology disclosed in this patent document can be implemented to provide a hybrid quantum classical computing system to include a cryostat system structured to include different cryogenic stages operable to provide a low cryogenic temperature and higher cryogenic temperatures. A quantum computing module is enclosed by the cryostat system at the low cryogenic temperature and is structured to include different quantum bit circuits that exhibit different quantum states and perform quantum computing operations. A quantum bit management circuit module is provided to be enclosed by the cryostat system and located adjacent to the quantum computing module to include quantum bit control circuits that generate and direct control signals to control the quantum bit circuits of the quantum computing module, and quantum bit readout circuits that respectively interact with and output readout signals indicative of quantum states of the quantum bit circuits, respectively, from the quantum bit circuits. This system also includes hierarchical circuit modules enclosed by the cryostat system at the higher cryogenic temperatures and structured to communicate with the quantum bit management circuit module in connection with the control signals and readout signals, and the hierarchical circuit modules are structured to include hierarchical quantum error correction decoding and hybrid quantum-classical co-processing circuit modules exhibiting increasing processing latencies and increasing decoding complexity levels along a direction of the different cryogenic stages as the different higher cryogenic temperatures increase. This system further includes a graphics processing unit (GPU) overlay module that includes one or more graphics processing unit (GPU) processors and a decoding module which are coupled to communicate with a last hierarchical circuit module enclosed by the cryostat system at a highest temperature of the higher cryogenic temperatures. The GPU overlay module is configured to perform quantum error correction decoding and hybrid quantum-classical co-processing based on quantum error correction decoding operations performed by the hierarchical circuit modules enclosed by the cryostat system and to carry out GPU processing operations.

In some implementations of the above system, the GPU overlay module and at least part of the hierarchical circuit modules include classical digital processors that are designed to perform certain computations based on the Boolean logic. In some implementations, GPU optimised decoders may also be implemented to provide neural network type decoding operations. For another example, CPU/FPGA optimised decoders may be implemented to provide decoding operations based on Union Find and Minimum Weight Perfect Matching. For yet another example, CPU optimised decoding may be operated on GPUs to provide efficient decoding operations.

The above and other embodiments, associated features and their specific implementations are described in detail in the drawings, the description and the claims.

### BRIEF DESCRIPTION OF DRAWINGS

FIGS. 1A, 1B, 1C, 1D and 1E show examples of hybrid quantum classical computing systems.

FIGS. 2, 3 and 4 show examples of Graphics Processing Unit (GPU) overlay with a quantum processing unit system to enable efficient computing operations using one or more GPU processors.

### DETAILED DESCRIPTION

The technology disclosed in this patent document can be implemented to leverage both of the quantum computing capabilities of a quantum computing system or quantum processing unit (QPU) system and digital computing capabilities of classical digital computer processors to provide a scalable hybrid quantum-classical computing systems for various computing applications. In particular, the classical digital computer processors can include graphics processing unit (GPU) processors to utilize parallel processing in GPU processors to provide GPU-enhanced or accelerated hybrid quantum-classical computing processing in the disclosed scalable hybrid quantum-classical computing systems.

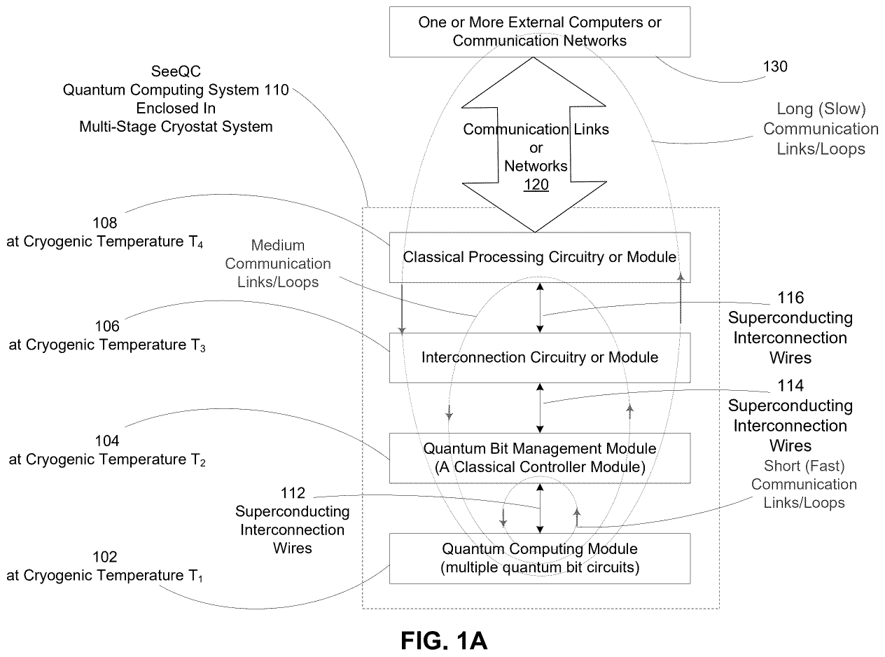

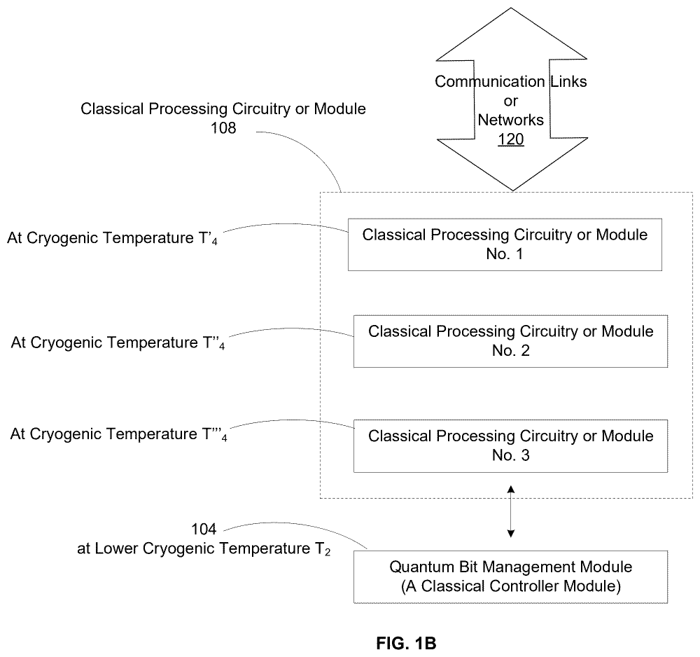

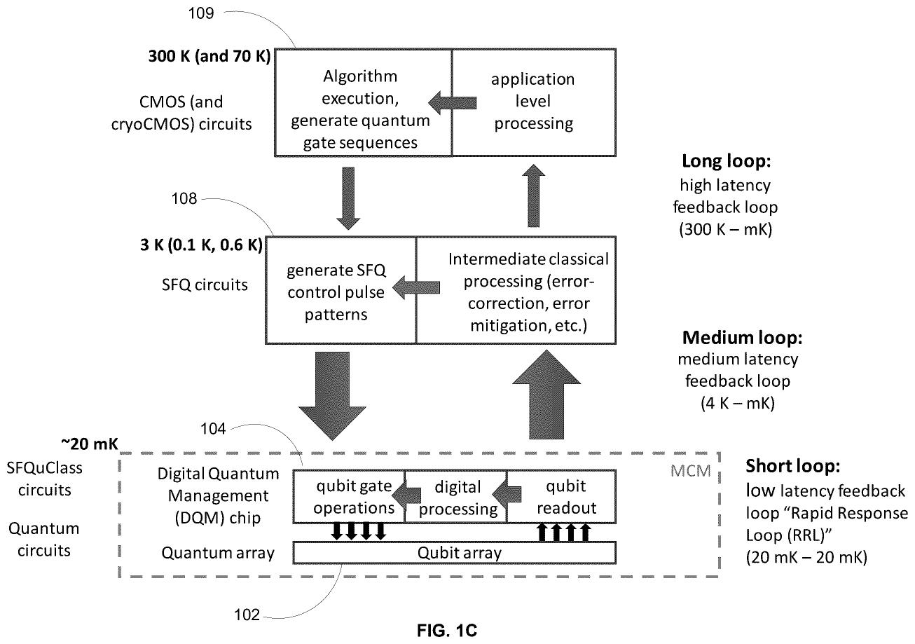

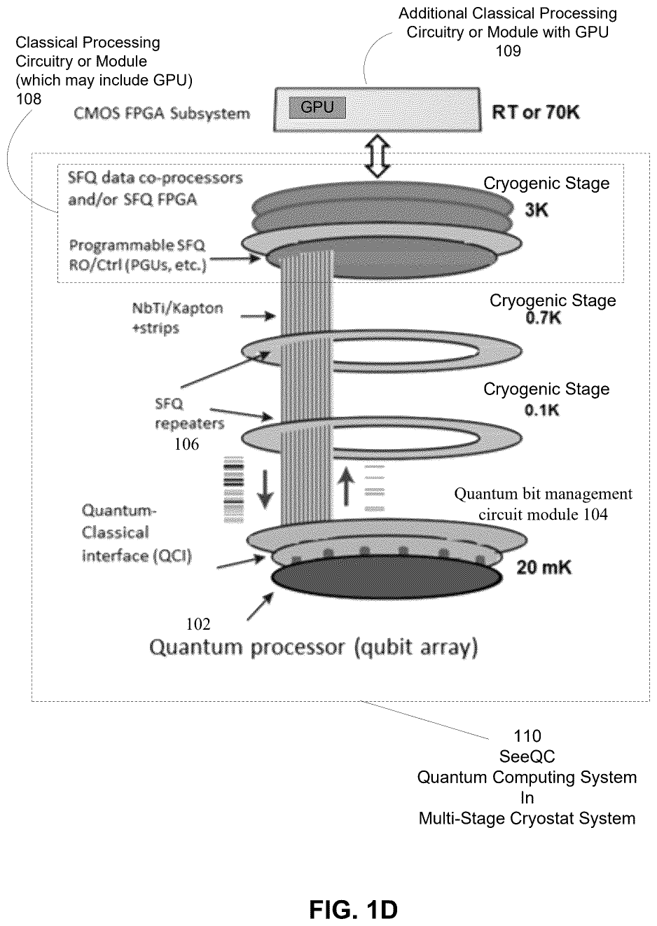

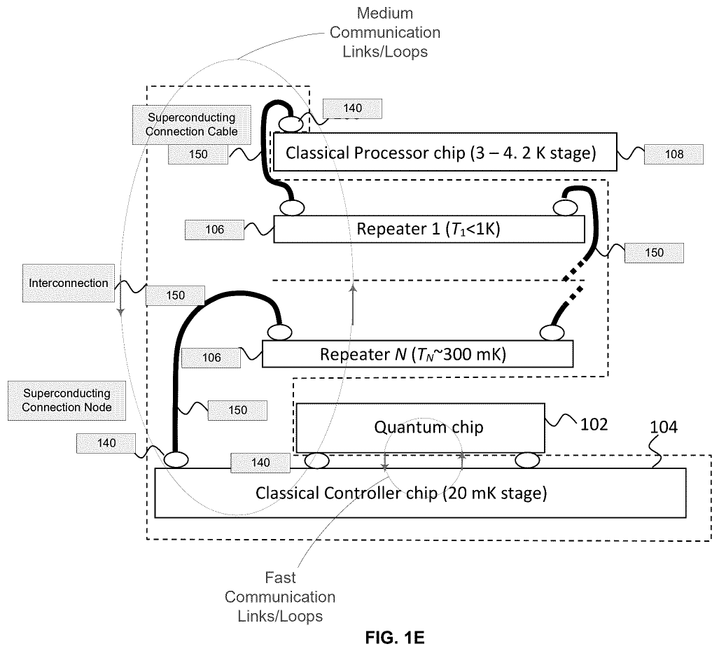

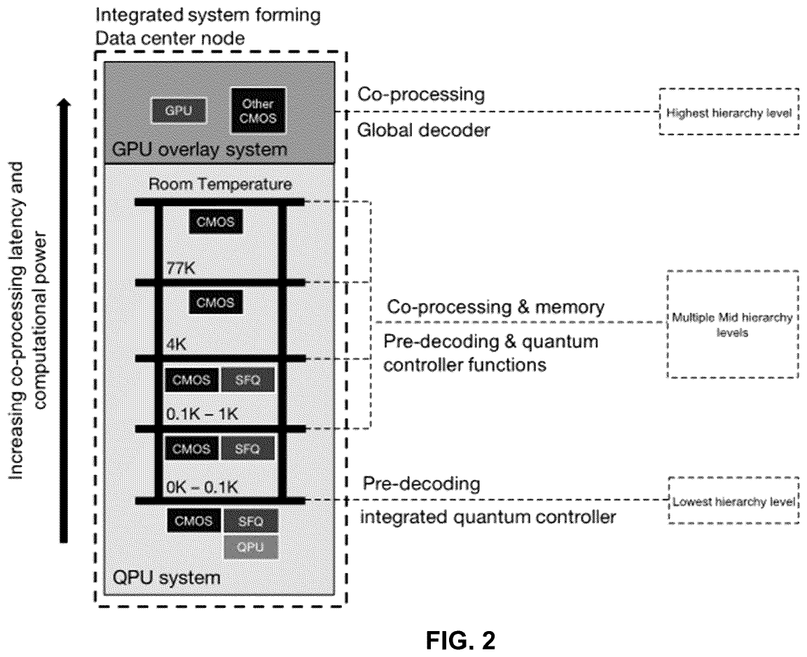

FIGS. 1A, 1B, 1C, 1D and 1E show examples of a QPU system and certain features. FIGS. 2, 3 and 4 show examples of computing systems with Graphics Processing Unit (GPU) overlay with a QPU system to enable efficient computing operations using one or more GPU processors in the GPU overlay.

The computing systems disclosed in this patent document include a quantum processing unit (QPU) system that carry out computations by using quantum states of an ensemble of subsystems each exhibiting two or more different quantum states to operate as a fundamental quantum device so that information can be represented, stored, processed, and transmitted by superposition and correlation of quantum states of different fundamental quantum devices. Such a fundamental quantum device can be a quantum bit circuit in various configurations, including a superconducting circuit operable at a sufficiently low cryogenic temperature to exhibit two or more different quantum states.

In general, QPU systems can be based on various QPU technologies including, e.g., superconducting Josephson junctions, ion trap devices based on electromagnetic trapping fields by laser beams, or semiconductor-based quantum dots. The examples of QPU systems below are implemented by using superconductor-based quantum computing modules (e.g., superconducting Josephson junctions) and by combining quantum computing modules or devices and classical digital computing modules or devices in ways that allow the systems to be scalable for complex computing applications. One of the features of the disclosed scalable hybrid quantum-classical computing systems is to strategically partition a system into different quantum and classical digital computing modules, devices or components at various cryogenic stages at different cryogenic temperatures. Such implementations of the disclosed technology can be used to simplify and reduce the complex and bulky cryogenic systems commonly used in various quantum computer systems using superconducting quantum computing devices and to reduce the use or level of use of complex superconducting cabling systems for linking different computing or processing modules. Implementations of the disclosed technology can be devised to allow for commercially scalable fabrication using integrated circuit (IC) fabrication processes and equipment in manufacturing key modules or devices for quantum computer systems based on superconducting Josephson junctions. The technology disclosed in this patent document can be implemented to provide special interconnection designs for connecting hardware components within a multi-stage cryogenic system to provide fast communications between the quantum computing module and its controller and classical digital computing modules, including GPUs while allowing efficient management of wiring with other modules.

FIGS. 1A, 1B, 1C, 1D and 1E show examples of hybrid systems for implementing scalable hybrid quantum-classical computing systems by connecting different hardware modules within a multistage cryogenic system.

FIG. 1A shows an example of a quantum computing system 110 to produce scalable hybrid quantum-classical computing systems for various computing applications. The quantum computing system 110, as its name implies, includes multiple qubit circuits and performs computing operations based on quantum states of the qubit circuits and is in communications with external computers or computing systems 130 via the communication links or networks 120. The communication links and networks 120 may include circuits where signals are transferred in the form of electromagnetic signals, including for example, electric signals carried by electrically conductive wires and/or optical signals. In operation, the quantum computing system 110 receives computation requests or tasks from one or more external computers or computing systems 130, performs the requested computation operations and sends the computation results back to the one or more requesting external computers or computing systems 130. The communications and/or interactions between the quantum computing system 110 and external computers or computing systems 130 are via the communication links or networks 120 and may constitute the longest communication cycle in time in the operations of the quantum computing system 110 and is labelled as the long communication links or loops. As further explained below, the quantum computing system 110 is structured to partition different internal computing modules so that those internal computing modules communicate via internal shorter communication links or loops such as medium communication links or loops with medium delays in time and fast communication links or loops with the shortest delays in time.

The quantum computing system 110 includes a multi-stage cryogenic system to provide different cryogenic stages at different locations and to maintain at different cryogenic temperatures for keeping different modules or devices at their respective desired temperatures (e.g., T1, T2, T3 and T4 as shown). In some implementations, the different cryogenic stages may be designed to produce temperatures from milli Kelvins to tens of Kelvins. This example system 110 includes one or more quantum computing modules 102 and each quantum computing modules 102 includes multiple qubit circuits or devices as the quantum qubit ensemble to perform desired quantum computing operations via their respective qubit states. In many implementations, the quantum computing module 102 is engaged or coupled to a cryogenic stage at a low cryogenic temperature T1 to ensure that qubit circuits or devices are under the desired superconducting condition and under acceptable quantum computing operating conditions at which the noise level and interference level are sufficiently low. A quantum bit management circuit module 104 is provided to be in communications with the quantum computing module 102 to provide control signals to the individual qubit circuits or devices of the quantum computing module 102 and to read out the individual qubit circuits or devices and may be implemented by using non-quantum mechanical processing circuitry such as digital circuitry or analogy circuitry or a combination of digital and analog circuitry. The quantum bit management circuit module 104 may be implemented with superconducting circuitry and is coupled to a cryogenic stage at a cryogenic temperature T2 which may be different from the low cryogenic temperature T1 in some implementations or be the same as the temperature T1 in other implementations. As further explained below, in some designs, the quantum computing module 102 and quantum bit management circuit module 104 may be engaged to share a common cryogenic stage so that both modules are kept at the same cryogenic temperature. The quantum bit management circuit module 104 can be structured to include (1) quantum bit control circuits to direct control signals to the quantum bit circuits to control the quantum bit circuits, respectively, and (2) quantum bit readout circuits to output readout signals from the quantum bit circuits, respectively. In this example, the quantum computing module 102 and quantum bit management circuit module 104 together form the “heart” or “core” of the quantum computing system 110 in part because the quantum computing operations are performed within the quantum computing module 102 based on the control signals to qubit circuits from the quantum bit management circuit module 104 and the readouts of the qubit circuits are performed by the quantum bit management circuit module 104. The communications between the quantum computing module 102 and quantum bit management circuit module 104 are essential to the quantum computing operations in terms of the quality and speed of such communications. Accordingly, in implementations, the quantum computing module 102 and quantum bit management circuit module 104 can be placed or positioned physically close to or adjacent to each other to shorten signal paths between the two modules 102 and 104 and to reduce any interference or noise to such communications. In addition, the functions or operations of the quantum bit management circuit module 104 may, by an intentional design, be limited to certain core functions or operations in connection with the quantum computations performed by the quantum computing module 102 so that the quantum bit management circuit module 104 can achieve a short or fast response or processing time to ensure fast input/output signaling at the quantum computing module 102. This intentional reduced function design consideration for the quantum bit management circuit module 104 is also based on the desire to reduce the power consumption and energy dissipation by the quantum bit management circuit module 104 to its surroundings in light of its close proximity to the quantum computing module 102, the noise or interference by the quantum bit management circuit module 104 to the quantum computing module 102 and the need for maintaining proper cryogenic conditions at the both the quantum bit management circuit module 104 and the adjacent quantum computing module 102. Based on the above and other considerations, the interconnections and signal paths between the two modules 102 and 104 are designed to form the fast communication link or loop with the shortest delay in time for the quantum computing system 110. For example, in some implementations, the quantum computing module 102 may include at least one integrated chip supporting one or plurality of quantum bit circuits, and the quantum bit management circuit module 104 may be formed on another integrated chip which is directly coupled to the integrated chip with the quantum bit circuits, mechanically and electrically, as a multichip module via superconducting bumps, capacitive coupling, or magnetic coupling via vacuum to transfer control signals and readout signals therebetween. This multichip module formed by the two modules 102 and 104 can be coupled to the same cryogenic stage at the low cryogenic temperature T1. This design can be commercially important because the chip fabrication for the multichip module formed by the two modules 102 and 104 is a scalable platform to allow a wide range of quantum bit circuits to be fabricated and included in the quantum computing module 102 and, similarly, the quantum bit management circuit module 104 may also be scaled based on the number of quantum bit circuits present.

The quantum computing system 110 in FIG. 1A further includes a digital processing module 108 that provides certain signal and data processing functions or operations for the quantum computing system 110 in connection with quantum computations performed by the quantum computing module 102 via the quantum bit management circuit module 104. In this regard, the digital processing module 108 forms the core processing module for non-quantum computation and/or processing functions within the quantum computing system 110 and thus is designed with much more complex circuitry and higher processing capabilities than the quantum bit management circuit module 104. Specifically, certain functions and/or processing operations that cannot be built into the quantum bit management circuit module 104 may be included in the circuitry of the digital processing module 108. In addition, the digital processing module 108 also functions as an interface between the quantum computing system 110 and one or more external computers or computing systems 130 via the communication links or networks 120. As such, the digital processing module 108 is designed to further include processing functions associated with communications and interactions between the quantum computing system 110 and external computers or computing systems 130. Therefore, different from the placement and design of the quantum bit management circuit module 104, the digital processing module 108 is designed to be a complex and capable classical counterpart and co-processor of the quantum computing module 102 of the quantum computing system 110. The increased functions and/or processing operations and processing capabilities packed into the digital processing module 108 add to the complexity and size of the circuitry of the digital processing module 108 and further increase the power consumption and energy dissipation of the digital processing module 108. Therefore, it is desirable to place the digital processing module 108 physically away from the quantum computing module 102 and its adjacent neighbor quantum bit management circuit module 104 to reduce the noise and interference that the digital processing module 108 may impose onto the quantum computing module 102. The digital processing module 108 may be designed with various functions and capabilities, including, e.g., error correction functions for the quantum computing system 110, and non-quantum computation and/or processing functions within the quantum computing system 110, including, e.g., functions in connection with the control of and readout of the quantum computing module 102 performed by the quantum bit management circuit module 104, and management of data of the quantum computations performed by the quantum computing module 102. In some implementations, the digital processing module 108 may be coupled to a cryogenic stage at a temperature T4 higher than those for the quantum computing module 102 (at T1) and quantum bit management circuit module 104 (at T1 or T2). The digital processing module 108 may be designed to include superconducting circuitry and is enclosed within the multi-stage cryogenic system of the quantum computing system 110.

The intentional design for placing the digital processing module 108 away from the quantum bit management circuit module 104 leads to longer signal paths or links between the digital processing module 108 and the quantum bit management circuit module 104. Within the enclosure of the multi-stage cryogenic system, such signal paths or links may be formed by using superconducting wires or cables. Notably, the long lengths of such signal paths or links may cause a certain degree of signal degradation and one option for addressing this is to add one or more interconnection repeaters or signal conditioning circuits 106 between the digital processing module 108 and the quantum bit management circuit module 104 to condition the signals. Like other modules within the multi-stage cryogenic system, each interconnection repeater or signal conditioning circuit 106 may be engaged or coupled to a cryogenic stage at a temperature T3 higher than the temperature of the quantum bit management circuit module 104 (at T1 or T2) and lower than the temperature of the digital processing module 108 (at T4). For example, a digital signal conditioning circuit module 106 may include a superconducting circuit which conditions the control signals or the readout signals.

In some implementations, the quantum computing system 110 may further include a digital processing subsystem 109 outside the multistage cryogenic system or the cryostat system to communicate with the digital processing module 108 to perform an operation associated with supporting execution of quantum or quantum-classical algorithms and/or communication with one or more other computers or networks 130. This is shown in the examples in FIGS. 1C and 1D. This digital processing subsystem 109 outside the cryostat system may include one or more CMOS digital processors, one or more field-programmable gate arrays (FPGAs), or one or more application specific integrated circuits (ASICs), or one or more central processing units (CPUs).

The quantum processing performed by the quantum computing module 102 is the core of the quantum computing system 110 and the signaling and communications between the quantum computing module 102 and the rest of the system 110 play a significant role in the overall computing speed and performance of the system 110. The latencies in the signaling and communications between the quantum computing module 102 and the rest of the system 110 are important parameters to optimize in order to achieve scalable hybrid quantum-classical computing systems for commercial applications. During operation, information is passed between the quantum computing module 102 and the other processing modules and computing entities involved in the computation performed in the quantum computing system 110. As illustrated, different communication links and/or feedback loops are formed between the quantum computing module 102 and the non-quantum modules and others in the system 110. The fastest link/loop, labelled as the short loop in FIG. 1A, is between the quantum computing module 102 and the quantum bit management circuit module 104. This link/loop can be compared with the communication link/loop formed between the quantum computing module 102 and the digital processing module 108, which experiences a longer latency as 1) communication between these modules must traverse a longer distance, including passing through the quantum bit management module 104 which may perform its own operations on the data cycling between the quantum computing module 102 and digital processing module 108, and 2) the digital processing module 108 in general performs more complex processing operations. Thus, in FIG. 1A, communication between 102 and 108 is labelled as a medium communication link/loop. An even longer latency occurs between the quantum computing module 102 and external computers or computing systems 130, labelled as a long communication link/loop in FIG. 1A, again due to increased distance (encompassing both the communication paths and possible operations of the short and medium loops plus the communication links or networks 120) and complexity of processing operations as compared to the medium link/loop.

Therefore, the example of the quantum computing system 110 in FIG. 1A includes special design features to provide a hybrid computing environment that combines processing functions and/or operations by the quantum computing part (e.g., the quantum computing module 102) and non-quantum classical processing part (e.g., the quantum bit management circuit module 104 and digital processing module 108) and to strategically partition and allocate different amounts and types of processing functions and/or operations of the non-quantum classical processing part between the quantum bit management circuit module 104 and the digital processing module 108 in light of the intentional design for placing the quantum bit management circuit module 104 physically placed close to the quantum computing module 102 while distancing the quantum computing module 102 from the digital processing module 108.

In some implementations, the digital processing module 108 may be designed to include two or more different processing modules to optimize the computation speed and performance of the digital processing module 108. For example, the digital processing module 108 may be further divided into a series of modules, as shown in FIG. 1B, with different temperature stages of the cryogenic system housing one or more such modules. In general, the design of the quantum computing system 110 in FIG. 1A allows for optimization in placement of each module within the cryogenic system so as to balance its particular needs with respect to low latency (which favors close proximity to the quantum module 102) and ability to handle dissipation during processing operations (which favors higher temperature stages that are placed further away from the quantum module 102), as well as to make efficient use of the volume of the cryogenic system.

FIG. 1C shows an example for executing certain processing operations at different modules in the system 110 in FIG. 1A, specifically showing processing operations in the digital processing module 108, processing operations in the additional digital processing module 109 operated at a higher temperature than that of the digital processing module 108 and processing operations in the quantum bit management circuit module 104. As a specific example, FIG. 1C shows that desired quantum gate sequences produced by the additional digital processing module 109 based on information from the digital processing module 108 in light of the qubit readout from the quantum bit management circuit module 104 are sent to, and are processed by, the digital processing module 108 to generate SFQ control pulse patterns. The quantum bit management circuit module 104 receives such SFQ control pulse patterns to apply the received SFQ control pulse patterns and/or flux biases to the quantum module 102 to set the relevant qubits into the quantum gate sequences. This is an example for implementing the medium communication loop in FIG. 1A, communication between quantum computing module 102 and digital processing module 108 that includes the links with the quantum bit management module 104 or any interconnection module 106 between the modules 102 and 108. FIG. 1C further shows an example for implementing the short communication loop between the quantum bit management module 104 and the quantum computing module 102 where the qubit readout obtained from reading out the quantum computing module 102 is digitally processed by the quantum bit management module 104 and the processed information is further used by the quantum bit management circuit module 104 to apply SFQ control pulse patterns and/or flux biases to the quantum module 102.

In various implementations, the quantum computing module 102 and non-quantum classical processing part (e.g., the quantum bit management circuit module 104 and the digital processing module 108) are structured to include superconducting circuits or devices coupled to different cryogenic stages of the multistage cryogenic system and superconducting interconnection wires 112, 114 and 116 are provided and maintained at temperatures at different locations to transfer signals between different modules or stages. The multi-stage cryogenic system for the quantum computing system 110 may be implemented in various configurations including multi-stage dilution refrigerators whose operation principle is based on mixing of helium-3 and helium-4 to provide the different cryogenic stages at the different graded cryogenic temperatures. In some implementations, the cryostat system may include a nuclear demagnetization refrigerator or adiabatic demagnetization refrigerator.

The modules within the quantum computing system 110 may be implemented in various configurations. For example, each quantum bit circuit for the qubits in the quantum computing module 102 may include a superconducting Josephson junction circuit or a switching superconducting circuit different from a Josephson junction circuit. For example, the quantum bit management circuit module 104 may be implemented to include a superconducting Josephson junction circuit or single flux quantum (SFQ) logic circuit, or a quantum flux parametron circuit such as an adiabatic quantum flux parametron circuit, or a nanowire switch, or a superconducting ferromagnetic transistor, or a superconducting spintronic device, or a field-effect superconducting device. The digital processing module 108 may be implemented to include SFQ circuitry, field-programmable gate arrays (FPGAs), or one or more application specific integrated circuits (ASICs).

In the system in FIG. 1A, optical communication links may be used for transfer of signals, either as a replacement for certain electrically conductive wires or cables or as additional links in combination with electrically conductive wires or cables. An optical communication link can provide faster data transmission and increase the communication bandwidth. For example, optical communication can be used between the cryogenic stage with the highest temperature stage (e.g., the module 108 in FIG. 1A) and a room temperature stage. In implementations, optical transmitter and receiver devices are provided in such stages or circuit modules to enable transmission and reception of optical signals between the cryogenic stages situated at the highest temperature of the cryostat system and the room temperature electronics to provide communications therebetween. In some implementations, such optical communication links may be implemented between the module 108 and the CMOS FPGA subsystem.

FIG. 1D shows an example of a quantum computing system that is capable of information processing based at least in part on quantum computing using quantum states of quantum bits based on the design in FIG. 1A. The cryostat system in this example is structured and operable to provide different cryogenic stages at different temperatures 20 mK, 0.1K, 0.7K, and 3K. Different circuit modules at the different cryogenic stages are interconnected by superconducting wires such as NbTi/Kapton (or NbTi/polyamide) strips. The quantum computing module enclosed by the cryostat system includes a first integrated chip structured to support quantum bit circuits. Each quantum bit circuit is structured as a superconducting circuit to exhibit different quantum states as a quantum bit and to quantum mechanically interact with other quantum bit circuits via quantum entanglement to cause superposition or correlation of different quantum states of the quantum bit circuits. The quantum bit management circuit 104 module is located adjacent to the quantum computing module 102 and is coupled to be maintained at the same low cryogenic temperature as with the quantum computing module. The quantum bit management circuit includes a second integrated chip, quantum bit control circuits supported by the second integrated chip and structured to direct control signals to the quantum bit circuits to control the quantum bit circuits, respectively, and quantum bit readout circuits supported by the second integrated chip and structured to output readout signals from the quantum bit circuits, respectively. In operation, the readout signals represent quantum states of the quantum bit circuits, respectively, the quantum bit control circuits and quantum bit readout circuits are structured to include superconducting circuits and operable to operate with the control signals and readout signals based on digital processing and in a non-quantum classical manner. Notably, the second integrated chip is engaged to the first integrated chip to form a multichip module (MCM) to transfer control signals and readout signals.

FIG. 1E shows an example for implementing interconnections that link different hardware components of classical and quantum circuits in the example in FIG. 1A, 1C or 1D. The system example in FIG. 1E includes at least one classical non-quantum digital processing module 108 labeled as “Classical Processor Chip,” at least one SFQ repeater as part of the interconnection circuitry or module 106, at least one classical superconducting controller as part of the quantum bit management circuit module 104, which controls the quantum computing processor or module 102 with multiple qubit circuits or devices.

The interconnections in FIG. 1E are designed to include superconducting connection nodes or pads 140 and superconducting connection cables 150 for connecting the classical circuits 104, 106 and 108 and the quantum computing processor or module 102. As illustrated, superconducting connection nodes or pads 140 may be implemented as superconducting bumps in direct contact with one or more hardware components (102, 104, 106, 108) to be connected and can be used to provide connection between a hardware component and a superconducting cable. As explained with reference to FIG. 1A, the quantum computing module 102 and the quantum bit management circuit module 104 can be placed adjacent to each other to allow short connection paths between them for fast inter-module communications and can be thermally coupled to the same cryogenic stage at the same low cryogenic temperature. Notably, the communication links or loops between the classical superconducting controller as part of the quantum bit management circuit module 104 and the quantum processor chip 102 should be fast communication links or loops and superconducting bumps can be used for interconnecting the two modules 102 and 104 to enable fast exchange of information for quantum computing operations and readout. In some implementations, the quantum bit management circuit module 104 containing the classical controller chip can be positioned on the cold plate of a cryocooler immediately above or below the quantum computing module 102 to reduce noise and interference to the quantum computing operations by the qubit circuits or devices inside the quantum computing module 102. In some implementations, superconducting bumps can be configured or used in the form of fences or walls which produce compartments separating strip or microstrip lines or other on-chip transmission lines, as well as qubits or systems of multiple qubits from each other, in order to reduce the mutual crosstalk between the superconducting electronic elements or systems and to improve the quality factors of resonators.

In addition to direct electrical connections between the quantum computing module 102 and the quantum bit management circuit module 104, non-contact connections may be used to achieve the fast communications, including, for example, the differential capacitive coupling between the qubits and the passive transmission lines and magnetic coupling, both of which provide communication links without direct connections and allow for compensation of the geometric misalignments between the modules 102 and 104 and other components as a result of the fabrication process.

In the examples of two-state qubit circuits, quantum computing operations by qubit circuits or devices inside the quantum computing module 102 are different from a classical computer based on a deterministic Turing machine and Boolean bits of “0” and “1” binary qubit states and use quantum-mechanical phenomena such as superposition of binary “0” and “1” qubit states, entanglement between qubits, and interference between probability amplitudes of non-deterministic measurement outcomes to perform computing operations. Superconducting qubits inside the quantum computing module 102 can be implemented by superconducting Josephson junctions. A Josephson junction is a system consisting of weakly coupled superconductors exhibiting correlated, or coherent, states and behaves like a non-linear inductor which allows for building a quantum anharmonic oscillator. The two discrete energy level states of this anharmonic oscillator and their quantum superposition are used to create a qubit. Using Josephson junctions, several versions of superconducting qubits can be constructed, such as transmon, xmon, quantronim, fluxonium, etc.

The state of a qubit is controlled by applying a microwave signal to the qubit. In various implementations, the microwave signal generators may be room-temperature devices, whereas the quantum circuits comprising qubits operate at very low cryogenic temperatures in order to reduce undesired decoherence of qubits. Specifically, the wiring needed to provide microwave signals to qubit circuits may involve different segments maintained different temperatures from the room temperature to the lowest temperature at the cryogenic stage where a quantum circuit is situated, and thus may cause or introduce undesired electric noise, or excessive heat load. Such wiring for a significant number of qubit circuits may occupy a lot of space. Those factors can lead to undesired decoherence of qubit quantum states and pose a significant problem for scaling up the quantum computer. In order to overcome this problem, various techniques may be used to control the qubits in a fully integrated, cryogenic, hybrid quantum-classical processor as shown in FIGS. 1A-1E, including, for example, integration of superconducting qubits with classical superconducting digital logic families such as reciprocal-quantum-logic (RQL) as disclosed by Quentin P. Herr and Anna Y. Herr in “Ultra-low-power superconductor logic,” J. Appl. Phys. 109, 103903(2011 ), use of adiabatic quantum-flux-parametrons (AQFP) by O. Chen, R. Cai, Y. Wang, F. Ke, T. Yamae, R. Saito, N. Takeuchi, and N. Yoshikawa in “Adiabatic Quantum-Flux-Parametron: Towards Building Extremely Energy-Efficient Circuits and Systems,” Sci. Rep. 9, 10514 (2019), or the use of single-flux quantum (SFQ) technology by O. A. Mukhanov in “Energy-Efficient Single Flux Quantum Technology,” IEEE Trans. Appl. Supercond. 21, 760 (2011). As part of the interconnection design for the systems in FIGS. 1A-1E, the control of qubits can be implemented via an SFQ system to control the state of a qubit by applying a sequence of the SFQ pulses without the conventional use of microwave signals as disclosed in U.S. Pat. No. 9,425,804. Techniques for applying flux to a quantum-coherent superconducting circuit in the U.S. Patent Application Publication No. US 2015/0263736A1 may also be implemented. The readout of qubits may be implemented by quantum electrodynamics measurements disclosed in U.S. Pat. No. 9,692,423. Cryogenic CMOS (cryoCMOS) techniques may also be implemented in the systems in FIGS. 1A-1E, e.g. for controlling superconducting qubits. See E. Charbon, F. Sebastiano, A. Vladimirescu, H. Homulle, S. Visser, L. Song, and R. M. Incandela. “Cryo-CMOS for quantum computing”, Technical Digest—International Electron Devices Meeting, IEDM (2017), pp. 1-13. doi: 10.1109/IEDM.2016.7838410, and J. C. Bardin, E. Jeffrey, E. Lucero, T. Huang, O. Naaman, R. Barends, T. White, M. Giustina, D. Sank, P. Roushan, K. Arya, B. Chiaro, J. Kelly, J. Chen, B. Burkett, Y. Chen, A. Dunsworth, A. Fowler, B. Foxen, C. Gidney, R. Graff, P. Klimov, J. Mutus, M. McEwen, A. Megrant, M. Neeley, C. Neill, C. Quintana, A. Vainsencher, H. Neven, and J. Martinis. “A 28 nm Bulk-CMOS 4-to-8 GHz 2 mW Cryogenic Pulse Modulator for Scalable Quantum Computing”, IEEE J. Solid-St. Circuits 54, 3043-3060 (2019). Those references are incorporated by reference as part of the disclosure of this patent document.

Practical implementations of the systems in FIGS. 1A-1E require careful designs for the interconnections or interface between the quantum circuits of the quantum computing module 102 situated at a low cryogenic temperature (e.g., a certain millikelvin temperature) and classical processing circuits situated at higher temperatures (including the liquid helium temperature). The interconnections in the example in FIG. 1E include placing the quantum computing module 102 and the quantum bit management circuit module 104 next to each other on the same cryogenic stage of the dilution refrigerator without using any superconducting cables or wires 150 between the modules 102 and 104. Instead, superconducting bumps or pads 140 are used to physically join or bind the two modules 102 and 104 together. The signal paths between the two modules 102 and 104 can be implemented in various ways, include signaling via conductive paths formed though the superconducting bumps or pads 140 between the modules 102 and 104, or signaling via capacitive and/or magnetic coupling between the modules 102 and 104. The signal paths between the two modules 102 and 104 are designed to minimize the signal transmission time (e.g., by reducing or eliminating the amount wiring between the modules 102 and 104) and to form the fast communication links or loops in the system as explained above with respect to FIG. 1A.

In implementations where the two modules 102 and 104 are supported by two IC chips, the two chips may be stacked over each other and bonded to form a multichip module (MCM) which is, as an integrated unit, coupled to the same low temperature cryogenic stage so both modules 102 and 104 are operated under the same low cryogenic temperature. Superconducting bumps or pads 140 may be used as part of the binding of the two IC chips or modules 102 and 104. The interconnections in the example in FIG. 1E also implements combinations of superconducting bumps or pads 140 and superconducting cables or wires 150 where the superconducting bumps or pads 140 are used at terminals of the superconducting cables or wires 150 for connecting the wire terminals to devices. For example, in FIG. 1E, the quantum bit management circuit module 104 is shown to be connected to an interconnection circuitry or module 106 such as a digital signal conditioning circuit module via superconducting cables or wires 150 where two sets of superconducting bumps or pads 140 are used to join the two end terminals of each superconducting cable or wire 150 to the contacting points on the quantum bit management circuit module 104 and the corresponding interconnection circuitry or module 106. This use of superconducting bumps or pads 140 and superconducting cables or wires 150 can be applied to connections for other modules such as the connection between the digital processing module 108 and a corresponding interconnection circuitry or module 106 and a connection between different stages or digital signal conditioning circuit modules of the interconnection circuitry or module 106. As illustrated, such superconducting cables or wires 150 with superconducting bumps or pads 140 constitute part of the medium communication links and loops as explained above with respect to FIG. 1A.

In the above examples of hybrid quantum-classical computing systems in FIGS. 1A through 1E, the classical digital processing modules 108 and 109 may be implemented to include various classical digital processors such as central processing unit (CPU) processors, field-programmable gate arrays (FPGAs), application specific integrated circuits (ASICs), and graphics processing unit (GPU) processors to share and to collaborate with the quantum computing in the quantum computing module 102 of the QPU system.

With the presence of GPU processors, a hierarchical tiered GPU overlay system can be implemented to enable the GPU processing in the hybrid quantum-classical computing systems in FIGS. 1A through 1E. FIGS. 2, 3 and 4 show examples of hybrid systems with GPU overlay with a QPU system where GPU processors may be deployed along with other classical digital processors such as CPUs, FPGAs and ASICs.

In some implementations of the systems in FIGS. 2, 3 and 4 based on the system designs in FIGS. 1A through 1E, the QPU system itself may include cryogenic and room temperature controllers and functional components to support QPU control, readout, active reset, multiplexing, and co-processing and Fault tolerant operations. Fault tolerant operation of the QPU system, in addition to other components, requires a quantum error correction architecture, controllers for addressing and reading out qubits and decoding co-processors. It is desirable to minimize or reduce the latency to achieve efficient operation of fault tolerant operations. Additionally, it is desirable to minimize or reduce the latency to achieve efficient hybrid quantum classical computation. In this regard, low latency and high speed QPU system operation, including qubit readout, qubit reset, qubit feedback, or calibration functions may be realized or facilitated in the GPU overlay for a QPU system utilizing specialized SFQ systems for efficient and functional quantum error correction architectures.

The GPU overlay in FIGS. 2, 3 and 4 provides hierarchical or tiered decoding operations based on the recognition that decoding in general is mathematically challenging and NP Hard in certain approaches. The GPU overlay of a QPU system here utilizes fast qubit controller functions, integrated with qubits. Referring to FIG. 2, the decoding functionality of the total system's fault tolerant operations is split across 2 or more hierarchical or tiered levels or stages to improve the accuracy and or increase speed and reduce latency of the decoding operations.

Additionally, this decoder hierarchy with 2 or more stages is designed to reduce the bandwidth of data transmitted across the different levels of the QPU and GPU overlay.

The decoder hierarchy is designed such that the first stage is proximally and programmatically closest to the qubits of the QPU to support the lowest latency, and is computationally-simple relative to the second and later stages that are more-complex decoders, with a final stage operating a global decoder with the highest computational complexity of all the stages.

The systems with GPU overlay in FIGS. 2, 3 and 4 include 2 or more hierarchical layers of classical co-processors for support of various fault tolerant operations of the QPU, including qubit controllers and hybrid quantum-classical computation. The system can include multiple hierarchical layers of co-processing and decoding with the lowest layer being proximally co-located at the same temperature as qubits to provide the lowest possible interface latency, and the mid to top layers offering increasing levels of computational power in support of fault tolerant operations and co-processing with increasing interface latency at higher hierarchy levels and at higher temperatures of the QPU.

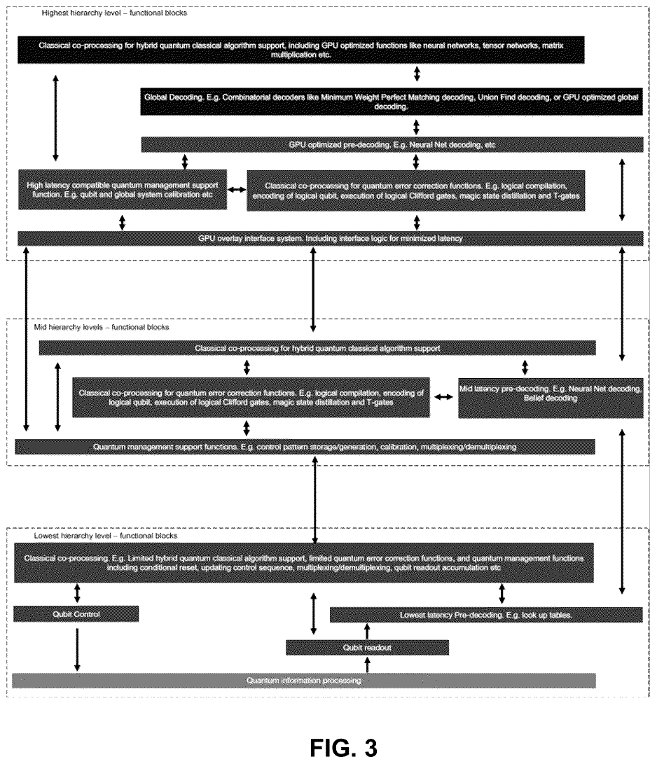

One of key functions of the hierarchical co-processing layers is to support decoding whereby the decoding computation is split across the levels of the hierarchy. This design is further illustrated in FIG. 3. Larger decoding logic blocks are supported at higher levels. The QPU system would include lower and middle hierarchical levels of co-processing at cryogenic temperatures at or below a desired low temperature, e.g., 4K. Additional hierarchy levels may be integrated within the QPU system at temperatures above desired low temperature (e.g., 4K). These levels would support pre-decoding and or local decoding type decoders that are used in conjunction with the GPU overlay which would support global decoding operations.

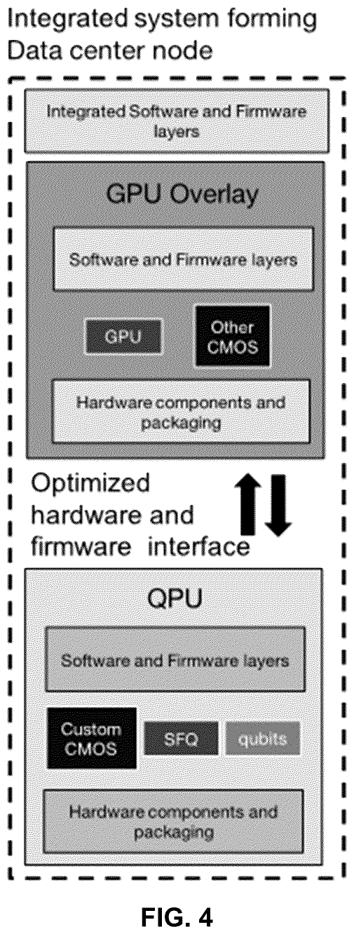

Referring to FIGS. 2 and 4, the GPU overlay system includes a GPU processor architecture (with one or more GPU processors) plus other CMOS based processor architectures to support integrated system functionality including fault tolerant QPU operations. The GPU overlay can support the highest hierarchy level global decoder as well as pre-decoding. The global decoder and pre-decoder may include, in some implementations, a neural network type decoder or other GPU optimized error correction decoding functionalities. To support complete quantum error correction decoding of the QPU, the global decoder and pre-decoder may include, in some implementations, CPU, FPGA or ASIC optimized decoding functionality including, for example, decoding algorithms like Union Find and Minimum Weight Perfect Matching. These decoding methods may be optimized to run on a GPU. The GPU system additionally has hardware component and packaging, and software and firmware layers to support GPU system functionality. Referring to FIGS. 1A-1E in connection with FIGS. 2 and 4, the GPU processors in the GPU overlay design may be deployed in the module 109 outside the cryogenic system or module 108 enclosed in the cryogenic system, or may be deployed in both modules 109 and 108, along with other classical digital processors such as CPUs, FPGAs and ASICs.

In certain implementations, the QPU system comprises a qubit plus SFQ plus custom CMOS processor architecture, proximally arranged across the various operating temperatures of the QPU cryostat support system, forming a first and additional hierarchical stages of the decoder and hybrid quantum-classical processor. The SFQ and CMOS processor architectures are optimized to support pre-decoding, local and greedy decoding which, in addition to other functions and co-processing, and could be implemented with neural network of different types or boolean logic look up tables. The QPU system additionally has hardware component and packaging, and software and firmware layers to support QPU system functionality.

The GPU overlay for QPU is created via a hardware and firmware interface optimized for high bandwidth and low latency. This total GPU overlay of QPU system includes integrated software and firmware layers to support system functionality such that this system can be operated as a single node in a data center and other computing systems or infrastructures.

Examples of certain hierarchy functions are further illustrated in FIG. 3. The hierarchical structure of the system is designed such that larger compute complexity can be integrated in the system at the higher hierarchy levels by taking advantage of the increased cooling power at the higher hierarchy levels.

The lowest hierarchy level will support the quantum information processing by the QPU as well as the lowest complexity and lowest latency classical logic, restricted by available cooling power. This classical logic is used to support QPU management functions including qubit control, qubit readout, and limited co-processing like (but not limited to) conditional qubit reset, updating control sequences, multiplexing/demultiplexing, qubit readout result accumulation etc. These management functions are to support quantum bit superposition, entanglement, and interference for quantum information processing. This lowest latency classical co-processing can also perform limited hybrid quantum-classical algorithm support and quantum error correction functions in support of physical and logical quantum circuit operations and analysis. In addition, this lowest hierarchy level will support the lowest level and lowest latency of a hierarchical quantum error correction decoder. The limited computational complexity integrated at this hierarchy level will support local error correction pre-decoding, for example binary logic look up table decoders or stored short distance look up tables, etc.

At the mid hierarchy levels, higher temperature cooling power allows for more complex compute which can support more complex co-processing logic as well as larger memory, including, e.g., Random Access Memory. This includes higher complexity quantum management functions for QPUs to support functions including qubit calibration, control pattern generation, multiplexing/demultiplexing and classical co-processing for hybrid quantum-classical algorithm logic and in support quantum circuit operations and analysis. Mid hierarchy levels may also be configured to support mid-level hierarchy quantum error correction pre-decoding supporting more complex decoding logic, for example, belief decoders and smaller Neural Net decoders, etc, on custom logic circuits. Mid hierarchy levels may include classical co-processing for quantum error correction functions including logical compilation, encoding of logical qubit, execution of logical Clifford gates, magic state distillation and T-gates in support of logical quantum circuit operation.

At the highest hierarchy level—the GPU overlay—the large computational complexity available supports advanced hybrid quantum-classical co-processing for application support, including GPU optimised functions like neural networks, tensor networks and large matrix multiplication etc. See FIG. 3. The highest hierarchy level also supports high latency compatible quantum management support functions including qubit and global system calibrations etc. This highest hierarchy level can be used to support the highest hierarchy level of quantum error correction decoding. This includes GPU optimised pre-decoders including large neural net or tensor network type decoders and combinatorial global decoders, for example, Union Find or Minimum Weight Perfect Matching decoders, that will operate on CPUs or custom CMOS processors (FPGAs or ASICs) or combinatorial decoders optimised for GPU operation. A GPU overlay interface system may be incorporated at this highest hierarchy level to provide interface functions and logic that provide an optimised and minimised latency interface between the QPU system and GPU overlay system.

Additional classical co-processing for quantum error correction functions may be included in support of mid and low hierarchy level functions.

The co-processing and decoding utilised at each hierarchy level may be optimised to take advantage of the lowest possible latency available between that level and the QPU.

Certain technical features of the disclosed examples above are described in a 2001 publication entitled “Scalable Neural Decoder for Topological Surface Codes” by Kai Meinerz, Chae-Yeun Park, and Simon Trebst (available at https://arxiv.org/pdf/2101.07285.pdf) and which disclose certain aspects of neural network decoders that could run optimally on GPU or optimised cryogenic SFQ based neural networks as discussed above. In addition, additional examples of technical features are disclosed in a 2022 publication entitled “Hierarchical decoding to reduce hardware requirements for quantum computing” by Nicolas Delfosse with respect to general hierarchical decoding in quantum computing in general (available at https://arxiv.org/pdf/2001.11427.pdf).

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few embodiments and their implementations and examples of the disclosed technology are described, enhancements and variations of the disclosed embodiments and other embodiments can be made based on what is described and illustrated in this patent document.

What is claimed is what is disclosed or/and illustrated, including:

1. A system capable of information processing based on both quantum computing using different quantum states of quantum bits and classical digital computing using digital processors including one or more graphics processing unit (GPU) processors, comprising:
a cryostat system structured to include different cryogenic stages operable to provide a low cryogenic temperature and higher cryogenic temperatures;
a quantum computing module enclosed by the cryostat system at the low cryogenic temperature and structured to include different quantum bit circuits that exhibit different quantum states and perform quantum computing operations;
a quantum bit management circuit module enclosed by the cryostat system, located adjacent to the quantum computing module to include quantum bit control circuits that direct control signals to control the quantum bit circuits of the quantum computing module, and quantum bit readout circuits that respectively interact with and output readout signals indicative of quantum states of the quantum bit circuits, respectively, from, the quantum bit circuits;
hierarchical circuit modules enclosed by the cryostat system at the higher cryogenic temperatures and structured to communicate with the quantum bit management circuit module in connection with the control signals and readout signals, wherein the hierarchical circuit modules are structured to include hierarchical quantum error correction decoding and hybrid quantum-classical co-processing circuit modules exhibiting increasing processing latencies and increasing decoding complexity levels along a direction of the different cryogenic stages as the different higher cryogenic temperatures increase; and
a graphics processing unit (GPU) overlay module that includes one or more graphics processing unit (GPU) processors and a decoding module which are coupled to communicate with a last hierarchical circuit module enclosed by the cryostat system at a highest temperature of the higher cryogenic temperatures, wherein the GPU overlay module is configured to perform quantum error correction decoding and hybrid quantum-classical co-processing based on quantum error correction decoding operations performed by the hierarchical circuit modules enclosed by the cryostat system and to carry out GPU processing operations.

2. The system as in claim 1, wherein the GPU overlay module is outside the cryostat system.

3. The system as in claim 1, wherein the GPU overlay module includes a part that is enclosed inside the cryostat system.

4. The system as in claim 1, wherein the GPU overlay module includes a part that is enclosed inside the cryostat system and another part that is outside the cryostat system.

5. The system as in claim 1, wherein the GPU overlay module is configured to provide a GPU optimised function associated with a neural network.

6. The system as in claim 1, wherein the GPU overlay module is configured to provide a GPU optimised function associated with a tensor network.

7. The system as in claim 1, wherein the GPU overlay module is configured to provide a GPU optimised function.

8. The system as in claim 1, wherein the GPU overlay module is configured to provide a GPU optimised function associated with complex matrix multiplication operations.

9. The system as in claim 1, wherein the GPU overlay module includes one or more GPU optimised pre-decoders.

10. The system as in claim 1, wherein the GPU overlay module includes one or more GPU optimised large neural net or tensor network type decoders.

11. The system as in claim 1, wherein the GPU overlay module includes one or more GPU optimised combinatorial decoders.

12. The system as in claim 11, wherein the one or more GPU optimised combinatorial decoders include Union Find or Minimum Weight Perfect Matching decoders.

13. The system as in claim 1, wherein the GPU overlay module includes one or more CPU, FPGA or ASIC optimised combinatorial decoders including Union Find or Minimum Weight Perfect Matching decoders.

14. The system as in claim 1, wherein some of the hierarchical circuit modules enclosed by the cryostat system at temperatures between the low cryogenic temperature and a highest temperature of the higher cryogenic temperatures are configured to provide quantum error correction functions including logical compilation, encoding of logical qubit, execution of logical Clifford gates, magic state distillation or T-gates.

15. The system as in claim 1, wherein:
the quantum computing module includes a first integrated chip structured to support the quantum bit circuits, wherein each quantum bit circuit is structured as a superconducting circuit at the low cryogenic temperature to exhibit different quantum states as a quantum-mechanical system and to quantum-mechanically interact with other quantum bit circuits via quantum entanglement to cause superposition or correlation of different quantum states of the quantum bit circuits; and
the quantum bit management circuit module is supported by a second integrated chip which is engaged to the first integrated chip to form a multichip module to transfer control signals and readout signals therebetween.

16. The system as in claim 1, further comprising one or more additional quantum computing modules enclosed by the cryostat system at the low cryogenic temperature, wherein each quantum computing module is structured to include different quantum bit circuits that perform quantum computing operations.

17. A method for computing based on both quantum computing using different quantum states of quantum bits and classical digital computing using digital processors including one or more graphics processing unit (GPU) processors, comprising:
operating a quantum computing module, that includes different quantum bit circuits that exhibit different quantum states, to perform quantum computing operations;
producing readout signals indicative of quantum states of the quantum bit circuits of the quantum computing module;
operating hierarchical quantum error correction decoding and hybrid quantum-classical co-processing circuit modules exhibiting different processing latencies and different decoding complexity levels in processing readout signals of the quantum bit circuits of the quantum computing module; and
operating a graphics processing unit (GPU) overlay module, that includes one or more graphics processing unit (GPU) processors and a decoding module which are coupled to communicate with the hierarchical quantum error correction decoding and hybrid quantum-classical co-processing circuit modules, to perform quantum error correction decoding and hybrid quantum-classical co-processing based on quantum error correction decoding operations performed by the hierarchical circuit modules to carry out GPU processing operations.

18. The method as in claim 17, further comprising operating the GPU overlay module to provide a GPU optimised function associated with a neural network.

19. The method as in claim 17, further comprising operating the GPU overlay module to provide a GPU optimised function associated with a tensor network.

20. The method as in claim 17, further comprising operating the GPU overlay module to provide a GPU optimised function associated with complex matrix multiplication operations.
